(19) United States
(12) Patent Application Publication
(10) Pub. No.: US 2023/0281039 A1
(43) Pub. Date: Sep. 7, 2023

(54) Efficient Scheduling of Build Processes Executing on Parallel Processors

(71) Applicant: EngFlow Inc., Austin, TX (US)

(72) Inventors: Ulf Adams, Groebenzell (DE); Yannic Bonenberger, Koeln (DE); Patrick Conrad, Cambridge, MA (US); Luis Pino, Muenchen (DE)

(21) Appl. No.: 18/117,893

(22) Filed: Mar. 6, 2023

Related U.S. Application Data
(60) Provisional application No. 63/317,189, filed on Mar. 7, 2022.

(51) Int. Cl. G06F 9/48; G06F 9/50; G06F 8/41

(52) U.S. Cl. CPC G06F 9/4881; G06F 9/505; G06F 9/5033; G06F 8/41

(57) ABSTRACT

A system schedules tasks using multiple processors. Examples of tasks include build tasks, training of machine learning models, and testing. The system groups the processors into a set of pools. A pool represents a set of processors associated with an affinity class. The system schedules execution of new tasks by determining an affinity class for a new build task based on characteristics of the new build task. The system identifies a pool matching the affinity class of the new build task. The system adds the new build task to the queue data structure of the pool matching the affinity class. The system adjusts the size of a pool based on a measure of workload associated with the pool. The system may determine the measure of workload as a weighted aggregate of various features describing the pool or using a machine learning model.

### CROSS REFERENCE TO RELATED APPLICATIONS

This application claims the benefit of priority under 35 USC 119(e) to U.S. Provisional Application No. 63/317,189 entitled “EFFICIENT SCHEDULING OF BUILD PROCESSES,” filed on Mar. 7, 2022, which is incorporated herein by reference in its entirety for all purposes.

### FIELD OF INVENTION

This disclosure relates generally to scheduling of tasks on parallel processors, and more specifically to scheduling of tasks related to software development life cycles, such as software compilation using multiple servers.

### BACKGROUND

Organizations typically execute large number of tasks using multiple servers. For example, organizations that perform significant software development activities perform tasks related to software development life cycles (SDLC) such as compilation, running of test cases (quality assurance), and so on. The goal of these tasks is typically to generate software artifacts based on source code, libraries, scripts and other input provided by developers. Individual tasks may be specified using build scripts that package related actions that are executed to perform the tasks. These tasks may be part of a pipeline of continuous integration/continuous delivery (CI/CD) of software artifacts. Build systems provide tools to help with this problem, but do not fully optimize for a parallel processing.

The efficiency of execution of these tasks can have significant impact on the end-to-end build times. For example, inefficient execution of build tasks may result in significantly higher end-to-end build times compared to other strategies. Poor execution of these build tasks results in inefficient utilization of computing resources. If the tasks are involved in a CI/CD (continuous integration/continuous deployment) pipeline of software artifacts, inefficient execution of individual tasks may slow down the entire pipeline used for CI/CD.

### SUMMARY

A system schedules tasks using multiple processors. Examples of tasks scheduled include build processes, training of machine learning models, testing, and so on. The system receives tasks for executing on a plurality of processors. A processor may also be referred to herein as a worker or a worker machine. A task may be a build task representing compilation of source code files specified using a programming language. The compilation is performed using a compiler of the programming language. The system groups the plurality of processors into a set of pools, each pool representing one or more processors for executing the tasks. A pool may be referred to herein as a server pool. The tasks for a pool are stored in a queue data structure. A pool represents a set of processors associated with an affinity class. Each affinity class is associated with characteristics of tasks assigned to the pool. For example, if the tasks are build tasks, an affinity class may be defined for a particular type of compiler. The system schedules execution of new tasks received as follows. The system receives a new build task. The system determines an affinity class for the new build task based on characteristics of the new build task. The system identifies a pool matching the affinity class of the new build task. The system adds the new build task to the queue data structure of the pool matching the affinity class.

According to an embodiment, the system adjusts the size of a pool based on a measure of workload associated with the pool. Accordingly, the system determines a new size of the pool based on factors including a size of the queue data structure storing build tasks for the pool. The system modifies the number of processors allocated to the pool based on the new size.

According to an embodiment, the system determines the measure of workload for a pool using a machine learning model trained to receive as input, features describing a pool and predict a size of the pool.

### BRIEF DESCRIPTION OF THE DRAWINGS

FIG. 1 is an overall system environment for scheduling tasks, in accordance with an embodiment.

FIG. 2 is the system architecture of a scheduler, in accordance with an embodiment.

FIG. 3 is the overall process of scheduling tasks using the scheduler, in accordance with an embodiment.

FIG. 4 illustrates an embodiment of a computing machine that can read instructions from a machine-readable medium and execute the instructions in a processor or controller, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A system schedules tasks across a set of processors, for example, worker machines. The system divides the set of processors into logical pools, each pool associated with an affinity class. For example, a pool may execute tasks representing compilation of source code files using a particular type of compiler. A task is associated with an affinity class. The system determines the affinity class of a new task and assigns the task to the pool corresponding to the affinity class. The system manages the sizes of the different pools as various tasks are processed. The system measures the current and past load on the pools to predict the future load for each affinity class and adjusts the pool sizes accordingly. The system achieves improvement in execution of tasks. For example, for build tasks, a factor of two improvement in end-to-end build times were measured. In some cases, task execution improved by a factor of ten times or more using the scheduler as disclosed.

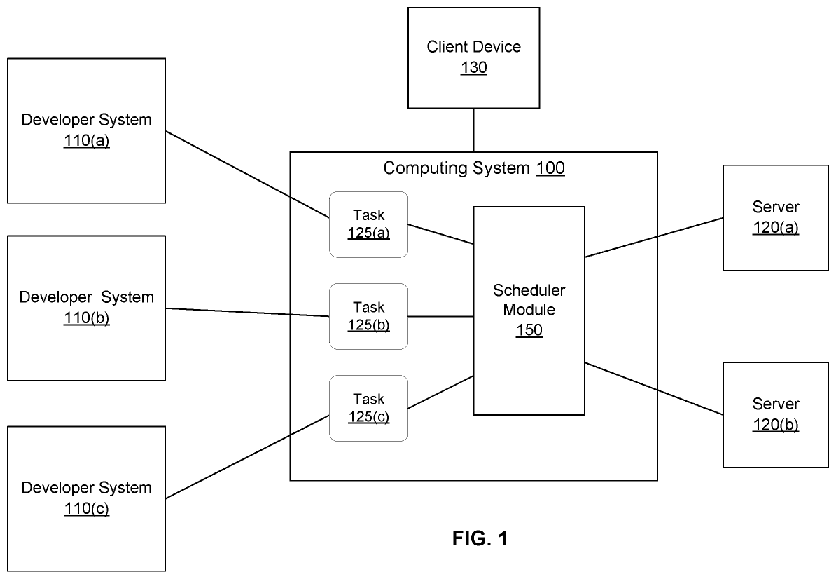

FIG. 1 is an overall system environment for scheduling tasks, in accordance with an embodiment. The system environment comprises a computing system 100, one or more developer systems 110, one or more severs 120, and one or more client devices 130. Other embodiments may include more or fewer components or systems than those indicated herein.

The developer systems 110(a), 110(b), 110(c) represent systems that provide tasks 125 to the computing system 100 for scheduling on one or more servers 120. In an embodiment, the tasks 125(a), 125(b), 125(c) represent build tasks, such as compilation tasks, execution of test cases, and so on. For example, the system may receive source code such as C++ code, Java code, and so on and use the corresponding programming language compiler to build software artifacts based on the source code. For example, if the system receives C++ code, the system uses appropriate C++ compiler to compile the C++ source code to executable files. Similarly, if the system receives Java code, the system uses Java compiler to compile the Java code into byte code. However, the scheduling techniques disclosed herein are not limited to scheduling of build tasks and can be applied to other types of tasks. For example, the tasks scheduled may be related to building of machine learning based models, for example, for training of machine learning based models.

The servers 120 represent computing machines that execute the tasks 125. Typically, the servers 120 represent powerful computing machines that may include multiple processors and significant amount of memory to store data while processing the tasks. For example, a server 120 is typically more powerful that a client device 130 or a developer system 110. A server may also be referred to herein as a computing machine, a machine, a processor, a worker machine, or a worker. Tasks may also be referred to herein as actions or jobs.

The following terminology is used herein. Scheduler system refers to a machine that runs a user interface (UI) and application programming interface (API) entry points, as well as handles various bookkeeping processes including scheduling. Worker (or server) refers to a computing machine that runs actions, for example, build processes. A single worker machine can run multiple actions in parallel. In an embodiment, a worker machine has a fixed number of slots for actions that are called executors. Accordingly, an executor refers to a single slot on a worker instance that can run one action at a time. Each executor maintains its own reuse state.

The computing system 100 includes a scheduler module 150 that schedules tasks 125 on servers 120. Accordingly, the scheduler module 150 determines which task 125 to run on which server. In an embodiment, the computing system 100 represents a distributed system (for example, a cluster) that may include multiple processors. There may be multiple instances of scheduler modules 150 that may execute on one or more processors. A task may also be referred to herein as an action.

The scheduler sends similar tasks, i.e., tasks belonging to a particular affinity class to servers belonging to a pool associated with that particular affinity class. A task is also referred to herein as a job. The jobs may be similar in terms of the executable files used for executing the jobs. For example, if a server S1 processes C++ compilation jobs, the scheduler continues sending more C++ compilation jobs to server S1. For example, if a server S2 processes Java compilation jobs, the scheduler continues sending more Java compilation jobs to server S2. Accordingly, the execution of subsequent jobs is efficient since the executable code needed to perform jobs of that particular type is already loaded and any initialization processes needed for performing that type of jobs have already been performed when subsequent jobs are received. The servers start any processes needed to execute the jobs of a particular type and keep those processes running and loaded in memory. Accordingly, if a compiler (for example, Java compiler) is started for compiling a particular job, the compiler may be kept running when the next compilation job is received for the same programming language and the overhead of restarting the compiler is not incurred. Furthermore, the executable files optimize their execution by loading any necessary data or libraries needed for execution. The data and executable instructions are loaded in fast storage, for example, random access memory (RAM) or cache memory of the corresponding servers.

Schedulers that send different types of jobs to the same server result in inefficient execution of the jobs since the server is unlikely to be able to load all the compilers in memory at the same time. As a result, the server has to unload a compiler from the memory and reload it later. This causes additional overhead in execution of the jobs. For example, a server may receive a compilation job for a programming language P1 and load the compiler for the programming language P1. After the server completed the compilation job based on programming language P1, if the server receives a compilation job based on programming language P2, the server may unload the P1 compiler from memory and load P2 compiler to perform the next P2 compilation job. If the next job received is again P1 compilation job, the server unloads the P2 compiler and re-loads the P1 compiler to perform the next job. Accordingly, every time the server receives a new type of job, the server incurs the overhead of loading new executable files for performing the new type of job, thereby incurring additional overhead. The scheduler according to various embodiments continues sending jobs of the same type to the same server, thereby avoiding the overhead of reloading executables for each job. This results in improved efficiency of execution of the build tasks. For example, experimental observations determined as much as a factor of 4 improvement in execution of jobs.

The computing system 100 may represent a cluster including one or more scheduler instances that interact with one or more servers. The servers may be heterogeneous, i.e., different servers may have different CPUs, memory, disk, network, operating system, and other hardware (e.g., GPUs, embedded systems) and software (e.g., low-level libraries, compilers, emulators). A server may be a virtual machine (VM), including one provided by a commercial third-party computing services platform such as Amazon Web Services or Google Cloud. Alternatively, the server may directly execute on physical hardware (e.g., bare-metal servers). A server may run in a cloud platform or in a datacenter.

A client device 130 or a developer system 110 used by a user for interacting with the computing system 100 can be a personal computer (PC), a desktop computer, a laptop computer, a notebook, a tablet PC executing an operating system, for example, a Microsoft Windows®-compatible operating system (OS), Apple OS X®, and/or a Linux distribution. In another embodiment, the client device 130 can be any device having computer functionality, such as a personal digital assistant (PDA), mobile telephone, smartphone, wearable device, etc. The client device 130 may be used by a user to manage the scheduler module 150 of the computing system 100 or for providing tasks for execution on servers. The client device 130 can also function as a computing system 100, but this is not a preferred embodiment if the tasks 125 that would be assigned to the client device would consume the computing and/or storage resources of the client device to an extent that would degrade the performance of the client device for other preferred functions.

FIG. 1 and the other figures use like reference numerals to identify like elements. A letter after a reference numeral, such as “110(a)” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110(a)” and/or “110(n)” in the figures).

The interactions between the computing system 100 and the other systems shown in FIG. 1 are typically performed via a network, for example, via the Internet or a private local area network. The network enables communications between the different systems. In one embodiment, the network uses standard communications technologies and/or protocols. The data exchanged over the network can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network can also include links to other networks such as the Internet.

Although embodiments described herein concerns scheduling of build processes using parallel processors, the techniques disclosed apply to scheduling other types of tasks using parallel processors, for example, training of machine learning models, natural language processing tasks, testing of software, and so on.

### System Architecture

According to various embodiments, the scheduler places tasks/actions on servers/workers to satisfy following criteria: (1) The scheduler ensures that the physical placement of a task is consistent with hardware and software requirements of the task, e.g., if a task is specified to be run on a specific type of machine or operating system (e.g., Mac, the scheduler sends the task to corresponding type of machine or a machine with the corresponding operating system MacOS actions have to run on MacOS machines. (2) If there are more actions than available machine resources, the scheduler queues the actions. However, the system ensures that actions are not queued indefinitely. If there are no machine resources available, the scheduler may fail after a configurable amount of time to prevent the scheduler from hanging builds indefinitely and to protect the cluster. (3) According to an embodiment, the scheduler supports user-specified priority-based scheduling, where the system prefers execution of higher-priority actions over lower-priority actions. (4) According to an embodiment, the scheduler selects machines to minimize end-to-end build time. (5) According to an embodiment, the scheduler executes actions in the order that they are received (FCFS—First Come First Serve) within a priority class unless there is a clear indication that reordering actions will improve end-to-end build times. (6) According to an embodiment, the scheduler aims to minimize scheduling delay by finding a machine quickly; for example, the scheduler aims to run an action on an otherwise idle cluster without incurring significant scheduling delay.

According to an embodiment, the scheduler prioritizes the above features in the order in which they are listed. For example, physical placement is given higher priority than minimizing end-to-end build time, and so on. Alternatively, the scheduler prioritizes the above features pursuant to a process that is dynamically updated through the use of machine learning. In this case, the machine learning model is trained on (1) historical data obtained from all previously run trials, and (2) the data that is being generated by running the current tasks. The machine learning algorithm utilizes the compute times and end results to further and continuously optimize the prioritization of tasks, thereby further enhancing performance. The system utilizes the optimal number of independent CPU executors, as each executor that is added increases total compute power but also adds startup overhead, etc.

In addition to prioritizing tasks, the scheduler reuses persistent worker processes. Reuse of worker processes for particular type of tasks results in significant performance improvement. Experimental results have shown an improvement of 4 times through reuse of existing persistent worker process for similar tasks. Reuse of worker processes also improves input/output performance, for example, improvement in performance of tasks that fetch input files. The scheduler places tasks/actions onto workers that already have some or most of the input files for that action locally. This results in significant reduction in input fetching times, which in turn results in improvement in end-to-end build times. According to an embodiment, the system allows reusable, or persistent, worker processes to operate remotely and in a parallel, distributed fashion, with cached data, thereby providing significant improvement to the results. Embodiments also reduce the cost of equipment and increases efficiency of utilization of available computing resources, for example, by utilizing spot instances (spare compute capacity available in a cloud platform), by caching and limiting the re-compute tasks, and by computing various build tasks on the lowest-cost hardware/plan for the task.

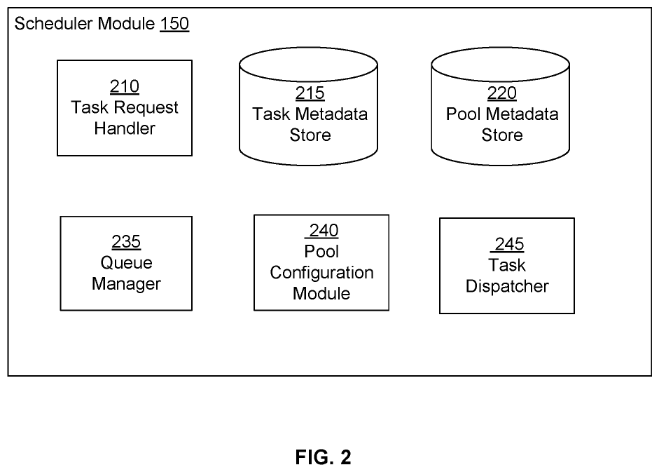

FIG. 2 is the system architecture of a scheduler module, in accordance with an embodiment. The scheduler module 150 includes a task request handler 210, a task metadata store 215, a pool metadata store 220, a queue manager 235, a pool configuration module 240, and a task dispatcher 245. Other embodiments may include fewer or more modules than those indicated herein. Functionality indicated herein as being performed by a particular module may be performed by other modules instead.

The task request handler 210 receives the tasks from external systems, for example, from developer systems 110(a), 110(b), 110(c). The tasks may be build-related tasks, for example, compilation jobs, but are not limited to build-related tasks. The tasks may be other tasks, for example, machine learning model training tasks, natural language processing tasks, and so on.

The task metadata store 215 stores metadata describing the various tasks received, for example, the attributes of the tasks needed to determine the pool for executing the task. For example, the system may analyze the commands specified for executing the tasks to determine the executables used by the task and determine the pool based on the executables. The task metadata store 215 may further store the status of the task, for example, queued for execution, dispatched for execution, or successfully completed execution. The task metadata store 215 may also store data used for analytics later produced for the user, for example, time elapsed for each task, success/failure results for each task, error codes, etc.

The pool metadata store 220 stores metadata describing various pools managed by the system. The metadata describing a pool may include the type of tasks executed by the pool, the current size of the pool, the individual servers currently included in the pool, and so on.

The queue manager 235 manages queues of task for execution. In an embodiment, the queue manager 235 manages one queue per pool. The task request handler 210 receives tasks and sends them to specific queues. In an embodiment, the task request handler analyzes the task to determine the pool that is appropriate for efficiently executing the task and sends the task for execution to a server selected from that pool.

The pool configuration module 240 determine the size of a pool based on various factors. The pool configuration module 240 configures the pool based on the size determined. For example, if a new size determined is higher than the current size of the pool, the pool configuration module 240 adds servers to the pool. Alternatively, if a new size determined is lower than the current size of the pool, the pool configuration module 240 removes one or more servers from the pool when these servers complete the current tasks that were executing on these servers.

The task dispatcher 245 sends the tasks to appropriate server for execution. In an embodiment, the task dispatcher picks a task from a queue for a pool, selects a server from the pool, and sends the task for execution to the server selected from that pool.

Various embodiments of scheduler are described herein. The scheduler according to an embodiment uses random assignment of actions to executors within each physical pool, queuing actions if none are available. A multi-scheduler cluster may be used by having separate queues for each physical pool on each scheduler and tracking available executors. When the scheduler picks an executor for an action, it makes an atomic compare-and-set operation on a distributed hashmap to reserve that executor. This simultaneously broadcasts that reservation to all other schedulers, all of which then update their internal state to indicate that that executor is no longer available. When an action completes, the owning scheduler releases the corresponding executor by removing the entry from the distributed hashmap, again broadcasting this information to all the other schedulers. As a safeguard against failed schedulers, entries also timeout after a fixed period of time such as 30 minutes. In some embodiments, the schedulers periodically refresh the hashmap entry and use a shorter timeout.

The scheduler according to another embodiment, reuses state for improving end-to-end build times. The scheduler keeps track of the reuse state of each executor. Accordingly, the system assigns every action to an affinity class based on the assumption that an action can reuse the state of a previous action with the same affinity class. The scheduler keeps track of the most recent affinity class used on an executor and preferentially picks matching machines when assigning new actions to executors. The scheduler performs this by keeping separate sets of executors for each affinity class in addition to a general set of all executors (in each physical pool). When picking a machine for an action, the scheduler first attempts to select an executor from the set for the corresponding affinity class. If the scheduler determines that the selected set is empty, the scheduler selects an executor from the general set. The system allows the executors, which may be remote, to communicate efficiently. This allows the system to access data required to process and optimize the tasks, thereby allowing the system to make operational determinations regarding optimal queuing and task scheduling and distribution, and report results to users.

The scheduler groups the executors into pools, each pool representing a group of executors. A pool may be a physical pool of executors, i.e., a set of distinct executors. The scheduler may subdivide each physical pool into a number of logical pools, with each logical pool having its own queue. Accordingly, the scheduler effectively reserves the executors in a logical pool for a specific affinity class. The scheduler updates the subdivision into logical pools over time as the cluster performs work and the load distribution on the cluster changes, while maximizing the amount of executor reuse within each affinity class. The scheduler measures the current and past load on the cluster in order to predict the future load for each affinity class and adjusts the logical pool sizes accordingly.

### Process for Scheduling of Tasks

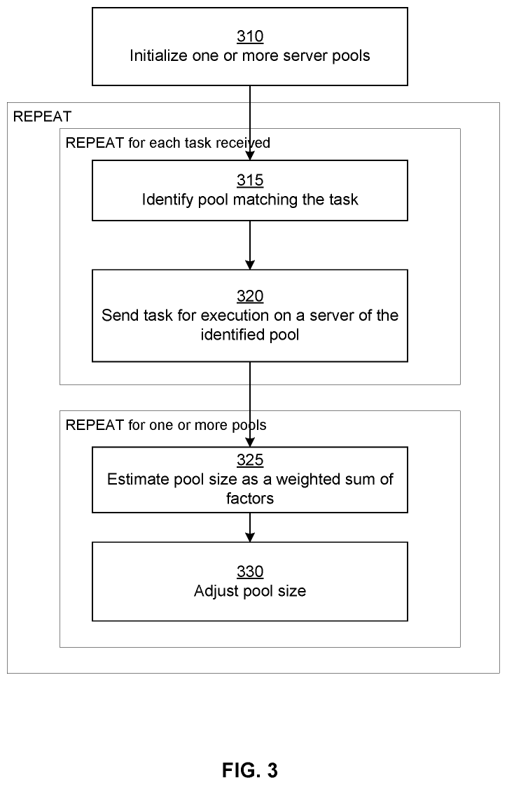

FIG. 3 is the overall process of scheduling tasks using the scheduler, in accordance with an embodiment. The steps shown in FIG. 3 may be executed in an order different from that indicated herein. The steps are described as being executed by the system and may be executed by one or more components of the system environment shown in FIG. 1, for example, by the scheduler module 150.

The system initializes 310 one or more pools, each pool associated with a type of task that is executed. The system repeats the following steps for executing tasks received and for adaptively adjusting the pools.

The system repeats the steps 315 and 320 for each task received. The system identifies 315 a pool matching the type of the received task. The system sends the task for execution to a server of the identified pool. According to an embodiment, each pool is associated with an affinity class. The affinity class represents a category of tasks determined based on a set of characteristics of the tasks. For example, an affinity class may represent tasks that use a specific compiler of a particular programming language for compiling source code files specified using that particular programming language, for example, JAVA compiler for compiling JAVA files. An affinity class may represent tasks that invoke a specific version of a compiler of a particular programming language. For example, tasks that invoke a version V1 of a compiler of particular programming language may form an affinity class C11 whereas tasks that invoke a version V2 of a compiler of particular programming language may form an affinity class C21. As another example, an affinity class may represent tasks that invoke a particular compiler using a particular set of configuration parameters. Accordingly, tasks that invoke a compiler of a particular language with a specific set S1 of configuration parameters may form an affinity class C21 whereas tasks that invoke a compiler of a particular language with a different set S2 of configuration parameters may form an affinity class C22. If some tasks process a particular file that stores large amount of data, an affinity class may be formed of the set of tasks that process that particular file. This allows the processors to cache the data of the input file, thereby providing efficiency of execution of the tasks by avoiding swapping in and out of data of that particular file.

The system repeats the steps 325 and 330 for one or more pools. The system estimates a pool size as a weighted sum of a set of factors. The system reconfigures the pool to adjust 330 the pool size. According to an embodiment, the system adjusts the size of a pool based on a measure of workload associated with the pool. Accordingly, the system determines a new size of the pool based on factors including a size of the queue data structure storing build tasks for the pool. The system modifies the number of processors allocated to the pool based on the new size. The adjustment of the sizes of the pools may be performed periodically. If the size of a pool is increased, the system allocated additional processors to that pool. In contrast, if the size of a pool is decreased, the system repurposes a subset of processors allocated to that pool for something else, for example, by moving them to another pool. According to an embodiment, the measure of workload for a pool is a predicted workload based on a measure of current workload and a measure of past workload.

The system determines pool sizes corresponding to different affinity classes as follows. The system determines relative pool allocations based on the expected work for each affinity class over the next horizon time period H. The value of H may be configurable and specified manually (e.g., 10 minutes). The expected work is a weighted sum of various factors. Examples of factors used to determine the pool size include currently queued work for the affinity class associated with the pool. Another factor used to determine the pool size is an estimate of expected future work over the horizon time period (also referred to as the induced wait time).

According to an embodiment, the system determines the measure of workload for a pool based on factors comprising the size of a queue data structure storing tasks for the pool. The system may determine the measure of workload for a pool based on factors including the square value of the size of a queue data structure storing tasks for the pool. According to an embodiment, the system determines the measure of workload for a pool based on factors including an estimate of expected amount of work for the affinity class associated with the pool. According to an embodiment, the system determines the measure of workload for a pool is determined based on factors comprising a product of a size of the queue data structure storing tasks for the pool and an estimated time for executing tasks assigned to the pool. According to an embodiment, the system determines the measure of workload for a pool is determined based on factors comprising an estimate of expected amount of work for the affinity class associated with the pool. According to an embodiment, the system determines the estimate of expected amount of work for the affinity class associated with the pool as the product of the average arrival rate of build tasks for the affinity class and the average processing time of build tasks for the affinity class. According to an embodiment, the system determines the estimate of expected amount of work for the affinity class associated with the pool as a weighted aggregate of factors including an estimate of past work for the affinity class and an estimate of current work for the affinity class. According to an embodiment, the system determines the measure of workload for a pool using a machine learning model trained to receive as input, features describing a pool and predict a size of the pool

In an embodiment, the system estimates the currently queued work as a function of the current queue length and an estimated time taken by actions on an executor. For example, the estimate of currently queued work is 1/2*Qᵢ²*Tᵢ where Qᵢ is the current queue length and Tᵢ the estimated action time on a warm executor. In other embodiments the estimate of currently queued work is a linear function of the current que length, for example, Qᵢ*Tᵢ.

In an embodiment, the system estimates the second quantity (induced wait time) as Wᵢ*H, where Wᵢ is the product of the average arrival rate and the average processing time. For simplicity, the system estimates Wᵢ directly instead of estimating the two constituents separately. The system then combines these two quantities into a total work estimate over the horizon H:

Dᵢ(H)=1/2*Qᵢ²*Tᵢ+Wᵢ*H

For each affinity class i, the system uses a pool size of Sᵢ=N*Dᵢ/ΣDᵢ, where N is the total number of executors. In the absence of queuing (cluster is large enough to handle all the work), the currently queued work is zero and the system determines the size the pools according to the product of estimated (historic) arrival rate and the estimated processing time, i.e., the system assigns each affinity class a number of executors according to the processing cost the system has monitored in the past.

In the presence of significant queuing, the system determines size of the pools primarily according to the estimated total queued work. This can happen, for example, if the incoming work is not distributed according to the estimated (historic) rates, for example due to a significantly higher rate of arrivals in one affinity class. This allows the scheduler to adjust more quickly in this case.

The system may receive the time horizon H from a user, for example, as a manually chosen weighting factor that determines how much queuing is significant. If the time horizon value is below a threshold value indicating that the weighting factor is too small, the system adjusts pool sizes fast, i.e., the pool sizes are adjusted if there's even a small amount of queuing. If the time horizon value if above a threshold value, indicating that the time horizon value is too large, the system ignores queuing.

Additionally, in an alternate embodiment, machine learning is utilized to further optimize estimates by training on more detailed features of the queued work, such as structural features of the work, and other factors. The system begins with the default estimates described herein, and the machine learning training process adjusts these estimates based on the results of the machine learning model. Accordingly, the training of the machine learning model utilizes both (1) feature inputs from various historical trial runs and (2) feature inputs from the current trial. The system may log the sizes of pools of various affinity classes. The system uses the logged values of sizes of pools of various affinity classes as labelled data for training machine learning models. According to an embodiment, the labelled data may be manually generated by specifying the pools sizes for various affinity classes based on various feature values. The machine learning model may be a regression-based model trained using supervised learning. According to another embodiment, the machine learning model is a neural network, for example, multi-layered perceptron that receives encodings of various attributes describing a pool associated with an affinity class. A multilayer perceptron is a neural network with input and output layers, and one or more hidden layers with multiple neurons stacked together. These attributes include average queue size over recent time interval, statistics describing the tasks received by the pool, types of machines of the pool, characteristics of the types of tasks of the affinity class associated with the pool and so on.

According to an embodiment, the system estimates the action time Tᵢ as follows. Whenever the system observes a new action time Tₘ, the system updates the estimate as T′ᵢ=Tₘ*f+Tᵢ*(1−f) for some constant f (e.g., f=0.01). Accordingly, the system uses an exponential moving average. The value of Tᵢ is typically non-zero even if no actions of that type arrive.

According to an embodiment, the system estimates the induced wait time Wᵢ as follows. The system divides a time interval into equal-sized periods (e.g., 1 minute). In each period, the system adds the observed processing times of all finished actions. The system determines the estimated induced wait time Wᵢ as the exponential moving average of the sums in chronological order. This trends to 0 if no actions complete over some time.

According to an embodiment, the system does not account for the cost of switching an executor to another affinity. In order to prevent oscillation, i.e., switching executors back and forth, the system may support manually preventing small adjustments to the pool sizes. If the change to the pool size is smaller than a threshold, the system does not change the pool size at all. However, if the previous pool size is 0, the system may force the pool size to have the value one.

The number of affinity classes is typically small relative to the number of executors. If the number of affinity classes exceeds a threshold value, all pools become very small and the system is not very efficient. To prevent this, the system limits the number of pools that the scheduler is allowed to create (e.g., to number of executors/10). The system assigns the least commonly seen affinity classes into a dedicated mixed pool. The system tracks information per affinity class within the mixed pool to determine if one of the classes in the mixed pool should be promoted to a dedicated pool. For example, the system tracks an average number of tasks for each affinity class assigned to the mixed pool. If the average number of tasks of a particular affinity class assigned to the mixed pool exceeds a threshold value, the system promotes that affinity class to an independent affinity class that is assigned a new pool distinct from the mixed pool.

### Computing Machine Architecture

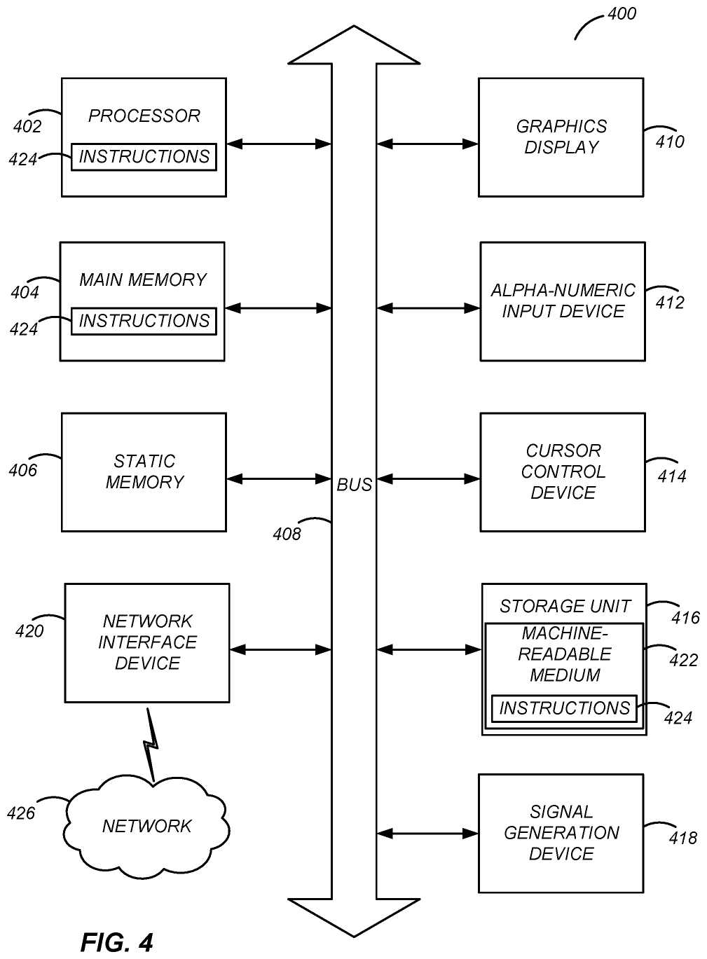

FIG. 4 illustrates an embodiment of a computing machine that can read instructions from a machine-readable medium and execute the instructions in a processor or controller, in accordance with an embodiment. Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to these signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating virtual databases from point-in-time copies of production databases stored in a storage manager. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for scheduling build tasks for execution using multiple processors, the computer-implemented method comprising:
receiving a plurality of build tasks for executing on a plurality of processors, wherein one or more tasks represent compilation of source code files specified using a programming language, the compilation performed using a compiler of the programming language;
grouping the plurality of processors into a set of pools, wherein tasks for a pool are stored in a queue data structure, wherein a pool represents a set of processors associated with an affinity class, wherein each affinity class is associated with characteristics of build tasks assigned to the pool; and
repeating for new build tasks received for execution:
receiving a new build task;
determining an affinity class for the new build task based on characteristics of the new build task;
identifying a pool matching the affinity class determined for the new build task; and
adding the new build task to the queue data structure of the pool matching the affinity class.

2. The computer-implemented method of claim 1, further comprising:
adjusting a size of a pool based on a measure of workload associated with the pool.

3. The computer-implemented method of claim 2, wherein adjusting the size of the pool comprises:
determining a new size of the pool based on factors comprising a size of the queue data structure storing build tasks for the pool; and
modifying a number of processors allocated to the pool based on the new size.

4. The computer-implemented method of claim 2, wherein the measure of workload for a pool is a predicted workload based on a measure of current workload and a measure of past workload.

5. The computer-implemented method of claim 2, wherein the measure of workload for a pool is determined based on factors comprising a size of the queue data structure storing tasks for the pool.

6. The computer-implemented method of claim 2, wherein the measure of workload for a pool is determined based on factors comprising a square value of a size of the queue data structure storing tasks for the pool.

7. The computer-implemented method of claim 2, wherein the measure of workload for a pool is determined based on factors comprising a product of a size of the queue data structure storing tasks for the pool and an estimated time for executing tasks assigned to the pool.

8. The computer-implemented method of claim 2, wherein the measure of workload for a pool is determined based on factors comprising an estimate of expected amount of work for the affinity class associated with the pool.

9. The computer-implemented method of claim 8, wherein the estimate of expected amount of work for the affinity class associated with the pool is determined as a product of an average arrival rate of build tasks for the affinity class and an average processing time of build tasks for the affinity class.

10. The computer-implemented method of claim 8, wherein the estimate of expected amount of work for the affinity class associated with the pool is determined as a weighted aggregate of factors including an estimate of past work for the affinity class and an estimate of current work for the affinity class.

11. The computer-implemented method of claim 2, wherein measure of workload for a pool is determined using a machine learning model trained to receive as input, features describing a pool and predict a size of the pool.

12. A non-transitory storage medium storing instructions that when executed by one or more processors, cause the one or more processors to perform steps comprising:
receiving a plurality of build tasks for executing on a plurality of processors, wherein one or more tasks represent compilation of source code files specified using a programming language, the compilation performed using a compiler of the programming language;
grouping the plurality of processors into a set of pools, wherein tasks for a pool are stored in a queue data structure, wherein a pool represents a set of processors associated with an affinity class, wherein each affinity class is associated with characteristics of build tasks assigned to the pool; and
repeating for new build tasks received for execution:
receiving a new build task;
determining an affinity class for the new build task based on characteristics of the new build task;
identifying a pool matching the affinity class determined for the new build task; and
adding the new build task to the queue data structure of the pool matching the affinity class.

13. The non-transitory storage medium of claim 12, further comprising instructions that cause the one or more processors to perform steps comprising:
adjusting a size of a pool based on a measure of workload associated with the pool.

14. The non-transitory storage medium of claim 13, wherein instructions for adjusting the size of the pool comprise instructions for:
determining a new size of the pool based on factors comprising a size of the queue data structure storing build tasks for the pool; and
modifying a number of processors allocated to the pool based on the new size.

15. The non-transitory storage medium of claim 13, wherein the measure of workload for a pool is determined based on factors comprising a product of a size of the queue data structure storing tasks for the pool and an estimated time for executing tasks assigned to the pool.

16. The non-transitory storage medium of claim 13, wherein the measure of workload for a pool is determined based on factors comprising an estimate of expected amount of work for the affinity class associated with the pool.

17. The non-transitory storage medium of claim 16, wherein the estimate of expected amount of work for the affinity class associated with the pool is determined as a product of an average arrival rate of build tasks for the affinity class and an average processing time of build tasks for the affinity class.

18. The non-transitory storage medium of claim 16, wherein the estimate of expected amount of work for the affinity class associated with the pool is determined as a weighted aggregate of factors including an estimate of past work for the affinity class and an estimate of current work for the affinity class.

19. The non-transitory storage medium of claim 13, wherein measure of workload for a pool is determined using a machine learning model trained to receive as input, features describing a pool and predict a size of the pool.

20. A computer system comprising:
one or more processors; and
a non-transitory storage medium storing instructions that when executed by one or more processors, cause the one or more processors to perform steps comprising:
receiving a plurality of build tasks for executing on a plurality of processors, wherein one or more tasks represent compilation of source code files specified using a programming language, the compilation performed using a compiler of the programming language;
grouping the plurality of processors into a set of pools, wherein tasks for a pool are stored in a queue data structure, wherein a pool represents a set of processors associated with an affinity class, wherein each affinity class is associated with characteristics of build tasks assigned to the pool; and
repeating for new build tasks received for execution:
receiving a new build task;
determining an affinity class for the new build task based on characteristics of the new build task;
identifying a pool matching the affinity class determined for the new build task; and
adding the new build task to the queue data structure of the pool matching the affinity class.
